(19) United States
(12) Patent Application Publication
(10) Pub. No.: US 2008/0036216 A1
(43) Pub. Date: Feb. 14, 2008

(54) Automatic rotating mechanism

(75) Inventor: Tsao-Thuan Lin, Taichung City (TW)

Correspondence Address: BIRCH STEWART KOLASCH & BIRCH, PO BOX 747, FALLS CHURCH, VA, 22040-0747, US

(73) Assignee: Tsao-Thuan LIN and Pang-Chi LIN

(21) Appl. No.: 11/498,190

(22) Filed: Aug. 3, 2006

(51) Int. Cl. H02K 7/18; F03G 7/08; F02B 63/04

(52) U.S. Cl. 290/1 R

(57) ABSTRACT

An automatic rotating mechanism is described. The automatic rotating mechanism includes a main wheel, a first auxiliary wheel, a second auxiliary wheel, a movable heavy wheel, a gravitational rotating metal belt and an arrestor. The first auxiliary wheel is disposed above the main wheel, and the second auxiliary wheel and the movable heavy wheel are respectively disposed on both sides of the main wheel. The gravitational rotating metal belt includes a flexible metal connecting device and a plurality of heavy blocks on the outside of the flexible metal connecting device. The arrestor can move upward of the movable heavy wheel and the gravitational rotating metal belt. When the arrestor is removed from the gravitational rotating metal belt and the movable heavy wheel, the gravitational rotating metal belt and the movable heavy wheel drop a predetermined distance to generate kinetic energy to output a rotating power.

### FIELD OF THE INVENTION

The present invention generally relates to an automatic rotating mechanism. More particularly, this invention relates to an automatic rotating mechanism with a heavy movable wheel and a gravitational rotating metal belt.

### BACKGROUND OF THE INVENTION

With the rapid growth in commercial/industrial activities and comfortable living needs in recent years there is a higher demand and dependency on electric power. Currently, electric power is generated mainly from nuclear power, coal, oil, gas, wind, ground heat, and solar energy.

The energy resources on the Earth are continuously exhausted. However, power consumption is increasing every day. Therefore, the environmental demands are increasing and environmental pollution is getting worse. In view of the limited energy resources on the Earth, it is imperative for scientists to find new substitute energy.

Currently, there are pros and cons for nuclear power usage; its further development, in particular, has caused a long-term debate. As to waterpower, most of the water resources have been utilized and the impact of waterpower to Nature is always criticized; its future is also very limited. In addition, the environmental pollution and greenhouse effect due to burning coals are not yet solved, either.

Facing foreseeable energy shortages in the future and under the condition of being unable to find new substitute energy, it is of consequence to use any method and mechanism to generate the power to reduce the energy crisis impact for humans.

### SUMMARY OF THE INVENTION

It is an objective of the present invention to provide an automatic rotating mechanism utilizing the kinetic energy of a gravitational rotating metal belt to drive a power generator to provide low-priced electric power.

It is another objective of the present invention to provide an automatic rotating mechanism automatically rotating to generate power output to drive any other apparatus.

To accomplish the above objectives, the present invention provides an automatic rotating mechanism. The automatic rotating mechanism includes a main wheel, a first auxiliary wheel, a second auxiliary wheel, a movable heavy wheel, a gravitational rotating metal belt, and an arrestor. The first auxiliary wheel is preferably disposed above the main wheel, and the second auxiliary wheel and the movable heavy wheel are preferably disposed on two sides of the main wheel. The movable heavy wheel is heavier than, for example, 4-6 times heavier than, the main wheel, the first auxiliary wheel and/or the second auxiliary wheel.

The gravitational rotating metal belt is composed of a flexible metal connecting device and a plurality of heavy blocks fixed on an outside of the flexible metal connecting device. The adjacent heavy blocks are separated by a gap with a predetermined width. The flexible metal connecting device surrounds the first auxiliary wheel, the second auxiliary wheel and the movable heavy wheel, and the main wheel is disposed under the gravitational rotating metal belt to form a fulcrum for supporting the gravitational rotating metal belt.

The arrestor for stopping the gravitational rotating metal belt is disposed under the movable heavy wheel and on the outside of the gravitational rotating metal belt to raise the movable heavy wheel and the gravitational rotating metal belt. The movable heavy wheel and the gravitational rotating metal belt may move down a predetermined distance to generate kinetic energy for rotating the gravitational rotating metal belt when the arrestor is removed from underneath the movable heavy wheel. The second auxiliary wheel is also driven by the gravitational rotating metal belt so as to output rotational energy.

The second auxiliary wheel preferably includes a power output shaft to output the rotational energy, and more preferably connects with a power generator to generator an electric power. For example, a belt, such as a V belt or a trapezoidal-shaped belt is used to connect the power output shaft and the power generator.

The distance between the axes of the movable heavy wheel and the second auxiliary wheel is larger than, preferable at least twice, that of the distance between axes of the second auxiliary wheel and the main wheel.

The movable heavy wheel is preferably heavier than the second auxiliary wheel by at least four or five times. The flexible metal connecting device is composed of a flexible metal belt or a plurality of rotatable hinges. The heavy blocks are preferably composed of metal.

Accordingly, the automatic rotating mechanism according to the present invention can utilize the gravitational rotating metal belt to generate kinetic energy to directly drive a machine or to drive a power generator to provide cheap electric power.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a preferred embodiment of the automatic rotating mechanism according to the present invention; and

FIG. 2 illustrates a preferred embodiment of the gravitational rotating metal belt of the automatic rotating mechanism according to the present invention.

### DETAILED DESCRIPTION OF THE PREFERRED EMBODIMENT

The following description is currently the best implementation of the present invention. This description is not to be taken in a limiting sense but is made merely to describe the general principles of the invention. The scope of the invention should be determined by referencing the appended claims.

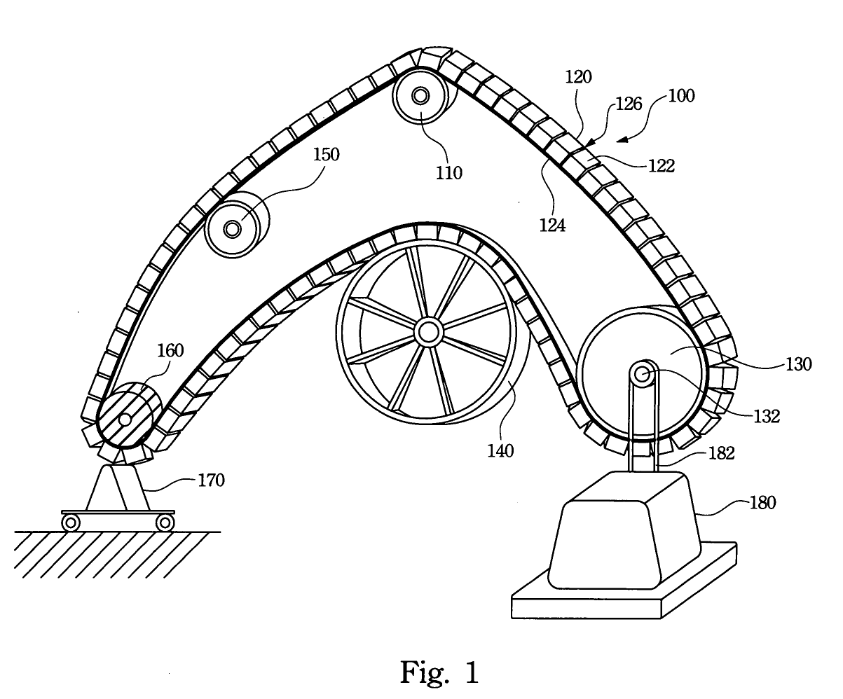

FIG. 1 illustrates a preferred embodiment of the automatic rotating mechanism according to the present invention. The automatic rotating mechanism 100 includes a main wheel 140, a first auxiliary wheel 110, a second auxiliary wheel 130, a movable heavy wheel 160, an arrestor 170 and a gravitational rotating metal belt 120.

The gravitational rotating metal belt 120 surrounds the first auxiliary wheel 110, the second auxiliary wheel 130 and the movable heavy wheel 160, and the main wheel 140 is disposed under the gravitational rotating metal belt 120 to support the gravitational rotating metal belt 120. The arrestor 170 is disposed under the movable heavy wheel 160 to support the gravitational rotating metal belt 120 and the movable heavy wheel 160. While starting the automatic rotating mechanism 100, the arrestor 170 is withdrawn outwardly to release the gravitational rotating metal belt 120 and the movable heavy wheel 160. Since the movable heavy wheel 160 is heavier than the main wheel and/or the auxiliary wheel, the gravitational rotating metal belt 120 and the movable heavy wheel 160 may move downward a predetermined height. Therefore, the gravitational rotating metal belt 120 starts to rotate because of change in the potential energy.

The gravitational rotating metal belt 120 is composed of a flexible metal connecting device 124 and a plurality of heavy blocks 122 disposed thereon. The heavy blocks 122 are preferably solid blocks, for example, metal blocks, plastic blocks, glass blocks and/or concrete blocks. The flexible metal connecting device 124 is preferably composed of a plurality of rotatable hinges and/or a flexible metal belt. Since each heavy block 122 provides a predetermined heavy weight, the total weight of the gravitational rotating metal belt 120 is heavier than the main wheel 140 and the auxiliary wheels, for example, more than 6 times the weight of the main wheel 140 and/or the auxiliary wheels.

The adjacent heavy blocks 122 are separated by a gap 126 to allow the gravitational rotating metal belt 120 to move around the main wheel 140, the first auxiliary wheel 110, the second auxiliary wheel 130 and the movable heavy wheel 160. The adjacent heavy blocks 122 are in touch with each other while the gravitational rotating metal belt 120 is reversely rotated. Therefore, the gravitational rotating metal belt 120 forms a rotatable lever structure between the main wheel 140 and the movable heavy wheel 160.

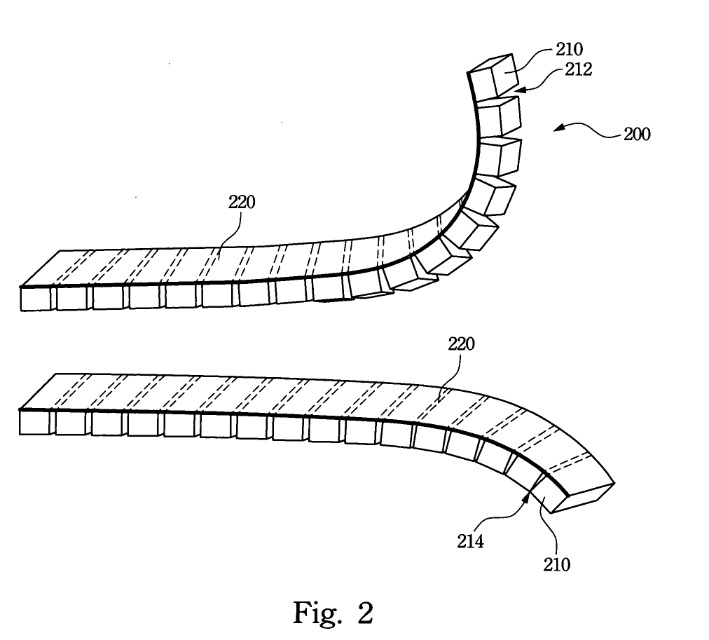

FIG. 2 illustrates a preferred embodiment of the gravitational rotating metal belt of the automatic rotating mechanism according to the present invention. The gravitational rotating metal belt 200 is preferably composed of a flexible metal connecting device 220 and heavy blocks 210. The adjacent heavy blocks 210 are separated by a predetermined gap. When the gravitational rotating metal belt 200 is rotated towards the flexible metal connecting device 220, the width of the gap 212 is proportional to a distance departing from the flexible metal connecting device 220. When the gravitational rotating metal belt 200 is rotated in a reverse direction, the width of the gap 214 gets smaller until the adjacent heavy blocks 210 are in touch with each other, that is, the width of the gap 214 is zero on the top surface of the heavy blocks 210.

Referring to FIG. 1 again, when the arrestor 170 is removed from underneath the movable heavy wheel 160, the heavy blocks 122 of the gravitational rotating metal belt 120 between the main wheel 140 and the movable heavy wheel 160 are in touch with each other. Therefore, the main wheel 140 becomes a fulcrum and the movable heavy wheel 160 becomes a point of application of a force. The axis of the main wheel 140 and the axis of the movable heavy wheel 160 preferably form at a 20-30 degree angle with the horizontal. Since the weight of the movable heavy wheel 160 and the gravitational rotating metal belt 120 is preferably heavier than the main wheel 140 and auxiliary wheels, the gravitational rotating metal belt 120 and the movable heavy wheel 160 may move downward to enforce the gravitational rotating metal belt 120 rotating around the main wheel 140 and auxiliary wheels when the arrestor 170 is moved out from underneath the movable heavy wheel 160.

The gravitational rotating metal belt 120 and the movable heavy wheel 160 are heavier than the main wheel 140, the first auxiliary wheel 110 and the second auxiliary wheel 130. The main wheel 140, the first auxiliary wheel 110 and the second auxiliary wheel 130 are preferably made of light material and/or structure. In addition, the friction coefficients of the main wheel 140, the first auxiliary wheel 110 and the second auxiliary wheel 130 are preferably very small. Therefore, when the gravitational rotating metal belt 120 starts to rotate, the movable heavy wheel 160 also starts to rotate, and the main wheel 140, the first auxiliary wheel 110 and the second auxiliary wheel 130 also start to rotate. Moreover, since the gravitational rotating metal belt 120 and the movable heavy wheel 160 are both heavy, the rotating power thereof can be output through a power output shaft 132 of the second auxiliary wheel 130. The power output shaft 132 can be connected to a machine that needs power directly or through a belt, for example, a V belt or a trapezoidal-shaped belt. The power output shaft 132 can further connected to a power generator 180 to generate electric power.

The distance between the axis of the main wheel 140 and the axis of the movable heavy wheel 160 is preferably larger than the distance between the axis of the main wheel 140 and the axis of the second auxiliary wheel 130, and more preferably the distance is at least two times greater. Furthermore, the automatic rotating mechanism 100 may further include a third auxiliary wheel 150 to support the gravitational rotating metal belt 120. The third auxiliary wheel 150 can effectively support the gravitational rotating metal belt 120 to avoid an upper part of the gravitational rotating metal belt 120 moving downward especially when the arrestor 170 is moved from underneath the movable heavy wheel 160. The auxiliary wheel 150 is preferably lighter than the movable heavy wheel 160. In a preferable embodiment, the movable heavy wheel 160 is heavier than the second auxiliary wheel 130, the first auxiliary wheel 110 or the third auxiliary wheel by about four times, and preferably by about five times.

Because the movable heavy wheel 160 and the gravitational rotating metal belt 120 are very heavy, both the movable heavy wheel 160 and the gravitational rotating metal belt 120 can start to rotate by way of the potential energy change thereof. When the movable heavy wheel 160 and the gravitational rotating metal belt 120 start to rotate, the main wheel and the auxiliary wheel are driven to rotate so as to continuously output rotational power output to a machine in want of energy. The rotating output power can be outputted through the power output shaft 132 directly or to generate an electric power with a power generator. Therefore, the automatic rotating mechanism according to the present application can provide cheaper electric power and energy to operate the machine.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

1. An automatic rotating mechanism, comprising:
a main wheel;
a first auxiliary wheel disposed above the main wheel;
a second auxiliary wheel disposed at one side of the main wheel;
a movable heavy wheel disposed at another side of the main wheel, wherein the movable heavy wheel is heavier than the main wheel, the first auxiliary wheel and the second auxiliary wheel;
a gravitational rotating metal belt composed of a flexible metal connecting device and a plurality of heavy blocks fixed on an outside of the flexible metal connecting device, wherein the adjacent heavy blocks form a gap with a predetermined width therebetween and the flexible metal connecting device surrounds the first auxiliary wheel, the second auxiliary wheel and the movable heavy wheel, and the main wheel is disposed under the gravitational rotating metal belt to support the gravitational rotating metal belt; and
an arrestor to stop the gravitational rotating metal belt disposed under the movable heavy wheel and on the outside of the gravitational rotating metal belt for raising the movable heavy wheel and the gravitational rotating metal belt, wherein the movable heavy wheel and the gravitational rotating metal belt moved down a predetermined distance to generate kinetic energy to rotate the gravitational rotating metal belt when the arrestor is removed from underneath of the movable heavy wheel and the heavy blocks between the movable heavy wheel and the main wheel are into touch with each other, wherein the second auxiliary wheel further comprises a power output shaft to output rotational energy.

2. (canceled)

3. The automatic rotating mechanism of claim 1, further comprising a power generator connected to the power output shaft to generate electric power.

4. The automatic rotating mechanism of claim 3, wherein the power generator and the power output shaft are connected with a belt.

5. The automatic rotating mechanism of claim 4, wherein the automatic rotating mechanism utilizes a rotatable lever structure and a potential energy change to generate the generate kinetic energy and rotate the gravitational rotating metal belt.

6. The automatic rotating mechanism of claim 1, wherein a first distance between axes of the movable heavy wheel and the second auxiliary wheel is larger than the second distance between axes of the second auxiliary wheel and the main wheel.

7. The automatic rotating mechanism of claim 6, wherein the first distance is larger than the second distance twice.

8. The automatic rotating mechanism of claim 1, wherein the movable heavy wheel is heavier than the second auxiliary wheel by at least four times.

9. The automatic rotating mechanism of claim 8, wherein the movable heavy wheel is heavier than the second auxiliary wheel by at least five times.

10. The automatic rotating mechanism of claim 1, wherein the flexible metal connecting device is a flexible metal belt.

11. The automatic rotating mechanism of claim 1, wherein the flexible metal connecting device is a plurality of rotatable hinges.

12. The automatic rotating mechanism of claim 1, wherein the heavy blocks are selected from the group of metal blocks, plastic blocks, glass blocks and concrete blocks.

13. An automatic rotating mechanism, comprising:
a main wheel;
a first auxiliary wheel disposed above the main wheel;
a second auxiliary wheel disposed at one side of the main wheel;
a movable heavy wheel disposed at another side of the main wheel, wherein the movable heavy wheel is heavier than the main wheel, the first auxiliary wheel and the second auxiliary wheel;
a gravitational rotating metal belt composed of a flexible metal connecting device and a plurality of heavy blocks fixed on the outside of the flexible metal connecting device, wherein the adjacent heavy blocks form a gap with a predetermined width therebetween and the flexible metal connecting device surrounds the first auxiliary wheel, the second auxiliary wheel and the movable heavy wheel, and the main wheel is disposed under the gravitational rotating metal belt to support the gravitational rotating metal belt;
a power generator coupled to the second auxiliary wheel to generate electric power when the second auxiliary wheel is rotated to drive the power generator; and
an arrestor to stop the gravitational rotating metal belt disposed under the movable heavy wheel and on the outside of the gravitational rotating metal belt to raise the movable heavy wheel and the gravitational rotating metal belt, wherein the movable heavy wheel and the gravitational rotating metal belt moved down a predetermined distance to generate kinetic energy for rotating the gravitational rotating metal belt when the arrestor is removed from underneath of the movable heavy wheel and the heavy blocks between the movable heavy wheel and the main wheel are into touch with each other.

14. The automatic rotating mechanism of claim 13, wherein the second auxiliary wheel further comprises a power output shaft and a belt to couple to the power generator.

15. The automatic rotating mechanism of claim 14, wherein the automatic rotating mechanism utilizes a rotatable lever structure and a potential energy change to generate the generate kinetic energy and rotate the gravitational rotating metal belt.

16. The automatic rotating mechanism of claim 13, wherein a first distance between axes of the movable heavy wheel and the second auxiliary wheel is larger than a second distance between axes of the second auxiliary wheel and the main wheel.

17. The automatic rotating mechanism of claim 16, wherein the first distance is twice as large as the second distance.

18. The automatic rotating mechanism of claim 13, wherein the movable heavy wheel is heavier than the second auxiliary wheel at least four times.

19. The automatic rotating mechanism of claim 13, wherein the flexible metal connecting device is a flexible metal belt or a plurality of rotatable hinges.

20. The automatic rotating mechanism of claim 13, wherein the heavy blocks are selected from the group of metal blocks, plastic blocks, glass blocks and concrete blocks.
